(19) United States
(12) Patent Application Publication
(10) Pub. No.: US 2016/0082542 A1
(43) Pub. Date: Mar. 24, 2016

(54) JOINED MEMBER AND METHOD FOR PRODUCING THE SAME

(71) Applicant: TOYOTA JIDOSHA KABUSHIKI KAISHA, Toyota-shi (JP)

(72) Inventors: Koichi HIRAMATSU, Toyota-shi (JP); Satoshi YAMAZAKI, Nagoya-shi (JP); Kazuhisa MAEDA, Toyota-shi (JP)

(73) Assignee: TOYOTA JIDOSHA KABUSHIKI KAISHA, Toyota-shi (JP)

(21) Appl. No.: 14/859,850

(22) Filed: Sep. 21, 2015

(30) Foreign Application Priority Data
Sep. 22, 2014 (JP) 2014-192349

(51) Int. Cl. B23K 11/11; B23K 35/02

(52) U.S. Cl. CPC B23K 11/11; B23K 35/0205

(57) ABSTRACT

To provide a joined member, which is obtained by joining members with different thickness (i.e., plate thickness) through resistance welding, with excellent welding quality and high strength, and a method for producing the same. A first member and a second member are joined together via a protruding portion that has been formed by plastically deforming a part of the first member at an end portion thereof such that the part of the first member has a reduced thickness and the part of the first member protrudes outward beyond the end portion.

### CLAIM OF PRIORITY

The present application claims priority from Japanese patent application JP 2014-192349 filed on Sep. 22, 2014, the content of which is hereby incorporated by reference into this application.

### BACKGROUND

1. Technical Field

The present invention relates to a joined member and a method for producing the same. In particular, the present invention relates to a joined member with excellent welding quality and high strength, and a method for producing the same.

2. Background Art

In spot welding, which is a type of lap resistance welding, plate-form members to be welded together (which are also referred to as workpieces) are typically overlaid one on top of the other at portions to be welded together, and the portions to be welded together of the members to be welded together are clamped with a pair of electrode tips, so that current is supplied across the pair of electrode tips to join the plurality of members to be welded together.

By the way, in such spot welding, it is known that if there is a difference in the plate thickness between the portions to be welded together of the members to be welded together, the center of a nugget to be formed will be unevenly located on the thicker plate side from the contact plane between the members to be welded together (though the center of a nugget is typically located at approximately the center position between a pair of electrode tips), and thus, a sufficient nugget cannot be formed at the contact plane between the members to be welded together. In particular, such a problem is prominent at a portion where a frame structure of a vehicle body, such as a center pillar obtained by joining a center pillar outer and a center pillar inner, which have approximately hat-shaped cross sections, together to form a closed cross-sectional structure, and further joining a side outer panel, which forms a design plane, thereto so as to cover the outer side of the center pillar outer, is formed because the difference in the plate thickness between each of the portions to be welded together of the members to be welded together is large.

Therefore, in such spot welding, reducing the plate thickness of a member to be welded, which is a thicker plate side, is considered to reduce the difference in the plate thickness between each of the portions to be welded together of the members to be welded together. Such conventional art is disclosed in Patent Documents 1 and 2.

In the conventional art disclosed in Patent Document 1, a reinforcement provided between an outer panel and an inner panel, which form a center pillar, is produced through press-forming using a plate material that is formed to have two different thicknesses when rolled (i.e., a plate material that is thinner at portions on the opposite sides thereof in the width direction than at the center portion) so that the reinforcement has a smaller plate thickness at flange portions thereof than at other portions.

In the conventional art disclosed in Patent Document 2, partial processing including cold stamping and hot stamping is applied so as to locally vary the thickness of a metal sheet that constitutes a vehicle component.

### RELATED ART DOCUMENTS

### Patent Documents

Patent Document 1: JP 2013-233838 A

Patent Document 2: US 2009/0266135 A

### SUMMARY

However, in the conventional art disclosed in Patent Documents 1 and 2, the thickness of the entire end portion of a reinforcement (i.e., a member to be welded), which partially constitutes a center pillar, for example, is reduced. Thus, when the member to be welded is joined to another member to be welded, there is a possibility that the strength of the resulting joined member may become small. Meanwhile, as disclosed in Patent Document 2, when the thickness of the entire end portion of a member to be welded is reduced by using cold or hot stamping, a compressive force is applied to the entire end portion of the member to be welded, and thus, a large load acts on or around the end portion of the member to be welded. Thus, it would be difficult to reduce the thickness of the entire end portion of the member to be welded with high precision, and there is even a possibility that the welding quality of the member to be welded may become low.

The present invention has been made in view of the foregoing problems. It is an object of the present invention to provide a joined member, which is obtained by joining members with different thickness (i.e., plate thickness) through resistance welding, with excellent welding quality and high strength, and a method for producing the same.

In order to achieve the above object, a joined member of the present invention is a joined member including a first member and a second member joined together through resistance welding, the first member being relatively thick and the second member being relatively thin. The first member and the second member are joined together via a protruding portion, the protruding portion having been formed by plastically deforming a part of the first member at an end portion thereof such that the part of the first member has a reduced thickness and the part of the first member protrudes outward beyond the end portion.

According to the aforementioned embodiment of the joined member, the first member, which is relatively thick, is joined to the second member, which is relatively thin, via a protruding portion that has been formed by plastically deforming a part of the first member at an end portion thereof such that the part of the first member has a reduced thickness and the part of the first member protrudes outward beyond the end portion, whereby the thickness of the end portion of the first member is partially reduced, and a load that acts on or around the end portion of the first member is reduced. Thus, the welding quality and the strength of the joined member can be effectively increased.

According to a preferred embodiment of the aforementioned joined member, the protruding portion is provided in an extended manner such that a surface of the protruding portion is flush with a surface of the first member on the second member side.

According to the aforementioned embodiment of the joined member, as the protruding portion is provided in an extended manner such that the surface of the protruding portion is flush with the surface of the first member on the second member side, the protruding portion formed on the first member and the second member can be made to contact with each other and can be joined together with a simple shape of the second member. Therefore, the welding quality and the strength of the joined member can be surely increased.

In a preferred embodiment of the aforementioned joined member, the protruding portion has the same thickness as the welded portion of the second member.

According to the aforementioned embodiment of the joined member, as the protruding portion has the same thickness as the welded portion of the second member, the first member and the second member can be joined together so that the center of a nugget formed through resistance welding is located at the contact plane between the protruding portion formed on the first member and the second member. Therefore, the welding quality and the strength of the joined member can be even more surely increased.

The present invention also relates to a method for producing the aforementioned joined member. A method for producing a joined member of the present invention is a method for producing a joined member, the joined member having a first member and a second member joined together through resistance welding, the first member being relatively thick and the second member being relatively thin, the method including forming a protruding portion by plastically deforming a part of the first member at an end portion thereof such that the part of the first member has a reduced thickness and the part of the first member protrudes outward beyond the end portion; and joining the first member and the second member together through resistance welding via the protruding portion.

As can be understood from the foregoing description, according to the present invention, in a joined member including a first member, which is relatively thick, and a second member, which is relatively thin, joined together through resistance welding, the first member and the second member are joined together via a protruding portion that has been formed by plastically deforming a part of the first member at an end portion thereof such that the part of the first member has a reduced thickness and the part of the first member protrudes outward beyond the end portion, whereby the thickness of the end portion of the first member is partially reduced, and a load that acts on or around the end portion of the first member is reduced. Thus, the welding quality and the strength of the joined member can be effectively increased.

### BRIEF DESCRIPTION OF THE DRAWINGS

FIG. 1 is an exploded perspective view showing a center pillar to which a joined member and a production method therefor of the present invention are applied in a disassembled state.

FIG. 2 is a partially enlarged exploded perspective view showing a part of the center pillar shown in FIG. 1 in a disassembled state.

FIG. 3 is a partially enlarged perspective view showing a part of the center pillar shown in FIG. 1 in a joined state.

FIG. 4A is a cross-sectional view along a line A-A of FIG. 3, FIG. 4B is a cross-sectional view along a line B-B of FIG. 3, and FIG. 4C is a cross-sectional view along a line C-C of FIG. 3.

FIG. 5 is a cross-sectional view along a line D-D of FIG. 3.

FIGS. 6A and 6B are views illustrating a method for producing the center pillar outer shown in FIG. 1; specifically, FIG. 6A is a view illustrating a method for taking materials of the center pillar outer, and FIG. 6B is a view illustrating a method for forming a protruding portion.

### DETAILED DESCRIPTION OF THE EMBODIMENT(S)

Hereinafter, embodiments of a joined member and a production method therefor of the present invention will be described with reference to the drawings. Although a case where the present invention is applied to a center pillar, which partially constitutes a frame structure of a vehicle body of an automobile or the like, will be described hereinafter, the present invention is not limited thereto. For example, the present invention can be applied to each pillar, such as a front pillar or a rear pillar, other than the center pillar, a rocker or a roof side rail at a side portion of a vehicle body, a front or rear bumper reinforcement of a vehicle body, and the like, and can also be applied to a variety of joined members that are formed by joining members with different thickness (i.e., plate thickness).

### [Embodiment of Joined Member]

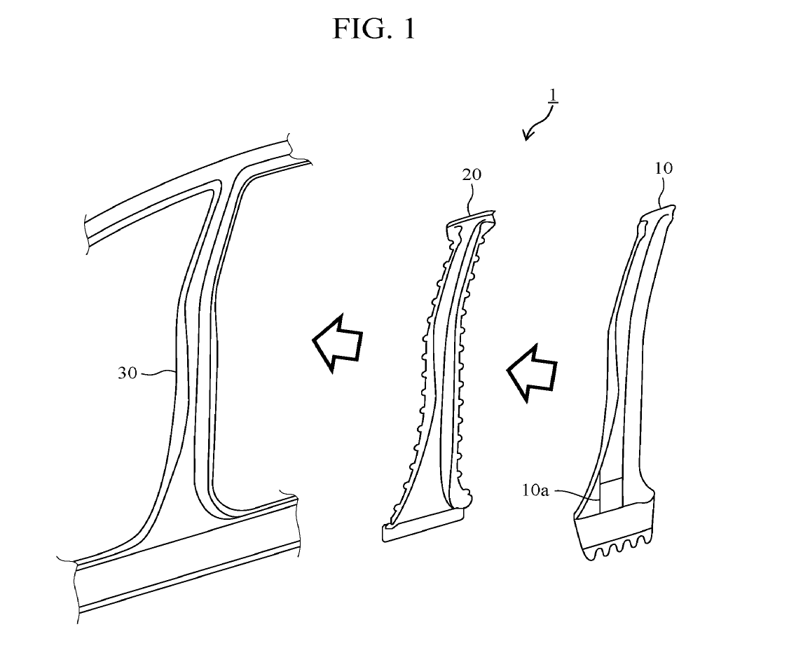

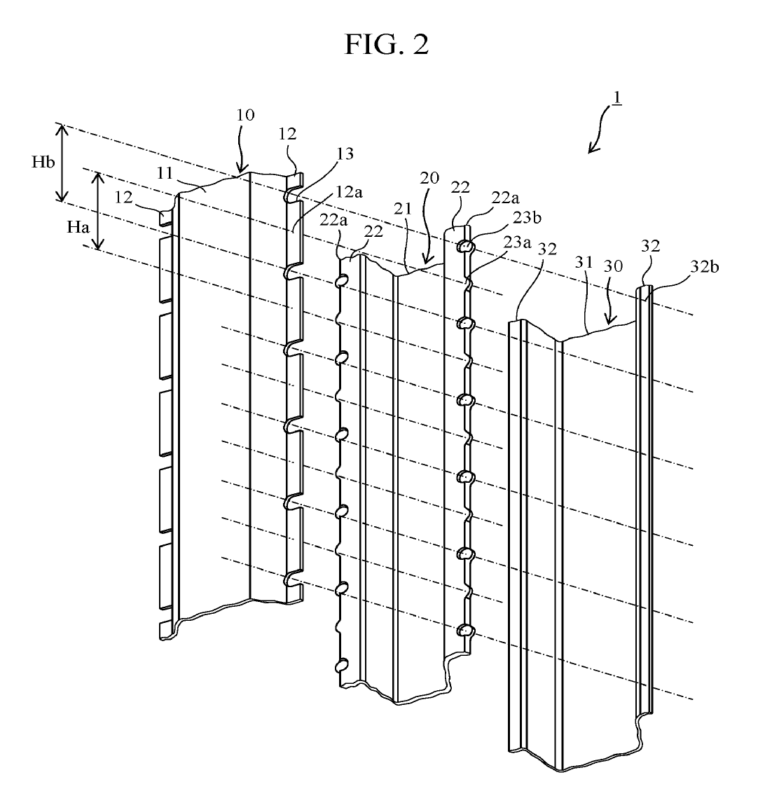

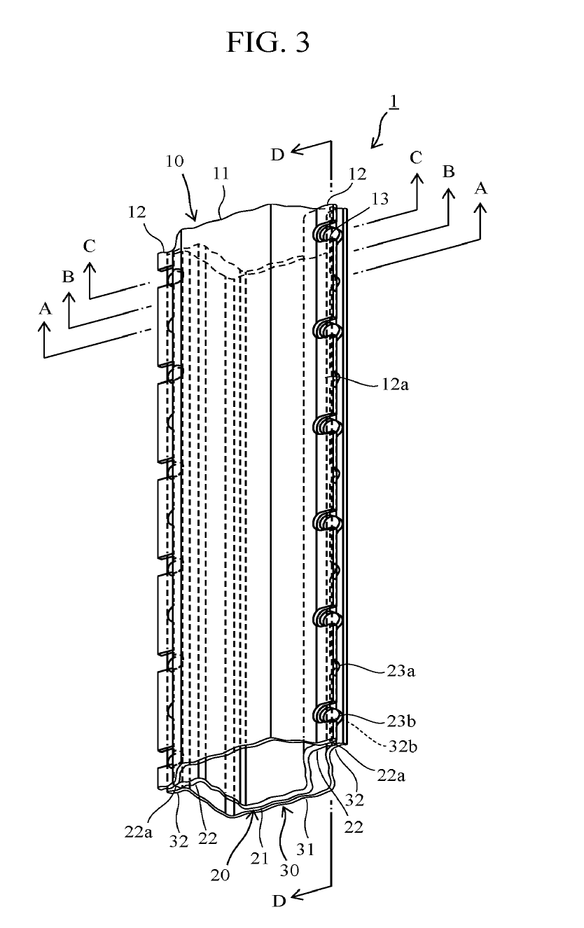

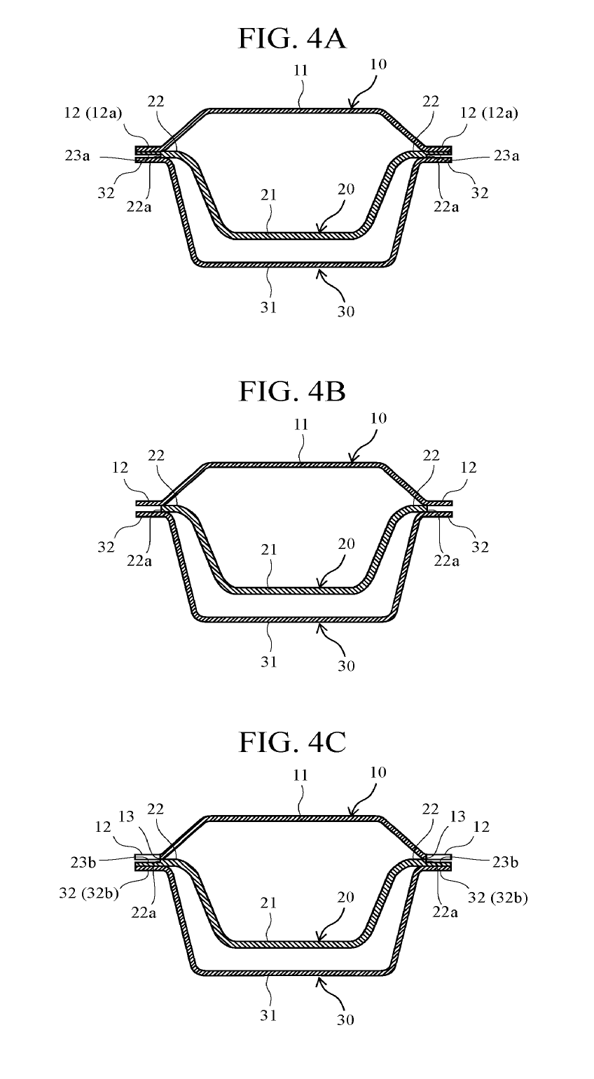

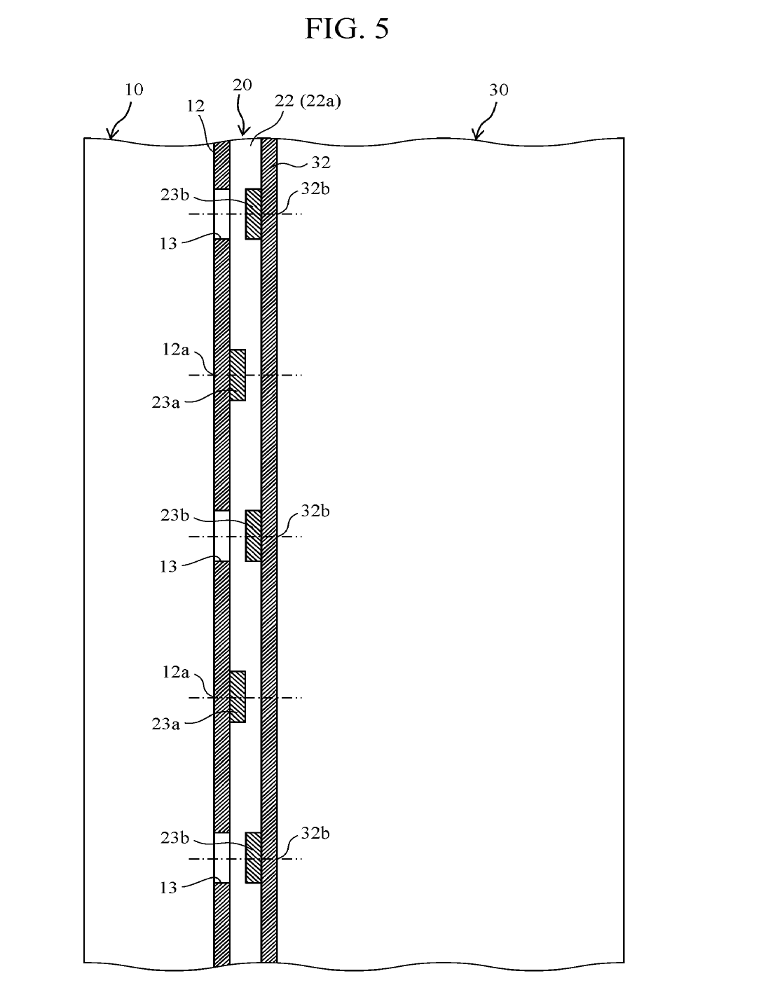

FIG. 1 is an exploded perspective view showing a center pillar to which a joined member and a production method therefor of the present invention are applied in a disassembled state. FIG. 2 is a partially enlarged exploded perspective view showing a part of the center pillar shown in FIG. 1 in a disassembled state. FIG. 3 is a partially enlarged perspective view showing a part of the center pillar shown in FIG. 1 in a joined state. FIG. 4A is a cross-sectional view along a line A-A of FIG. 3, FIG. 4B is a cross-sectional view along a line B-B of FIG. 3, and FIG. 4C is a cross-sectional view along a line C-C of FIG. 3. FIG. 5 is a cross-sectional view along a line D-D of FIG. 3.

It should be noted that FIG. 1 shows a center pillar at the right side portion of a vehicle body, and FIGS. 2 and 3 each show a center pillar at the left side portion of a vehicle body. In practice, the center pillar that partially constitutes a frame structure of a vehicle body also has joined thereto a member that constitutes a rocker or a roof side rail, a component for reinforcing the center pillar, and the like at the top portion, the bottom portion, and the middle portion thereof. However, for ease of understanding, each drawing shows only a center pillar inner, a center pillar outer, and a side member, and the following description contains detailed description of only weldbonding of the center pillar inner, the center pillar outer, and the side member. In addition, although each member that constitute the center pillar (i.e., the center pillar inner, the center pillar outer, and the side member in the drawing) typically has a complex cross section, the cross section of each member is shown in a simplified manner in each drawing and the following description for ease of understanding.

A center pillar 1 is, as shown in FIG. 1, a part of a frame structure that is provided in the vertical direction between a roof side rail and a rocker that extend in the front-rear direction of a vehicle body, and mainly includes, sequentially from the inner side thereof, a center pillar inner (which is also referred to as an inner reinforcement) 10, a center pillar outer (which is also referred to as an outer reinforcement) 20, and a side member (which is also referred to as an outer panel) 30. The center pillar 1 is formed by joining the center pillar inner 10 and the center pillar outer 20 together and joining the center pillar outer 20 and the side member 30 together. It should be noted that the center pillar inner 10 has an opening 10a for mounting a retractor (not shown), for example.

More specifically, as shown in FIGS. 2 to 5, the center pillar inner 10 is obtained by forming a plate material such that it has an approximately hat-shaped cross section, and mainly includes a recessed portion 11 that projects inward in the vehicle width direction (that is, opens to the outer side in the vehicle width direction) and flange portions (i.e., second members) 12 that extend in the front-rear direction from opposite end portions (i.e., the front end portion and the rear end portion) of the recessed portion 11. The flange portions 12 have run-off portions 13 made of cutouts (in the drawing, cutouts that have approximately U shapes as seen in a side view and that open in the front-rear direction) that are provided at predetermined intervals Hb in the vertical direction. Such run-off portions 13 are, when the center pillar outer 20 and the side member 30 are joined together after the center pillar inner 10 and the center pillar outer 20 are joined together, provided at positions corresponding to the welded portions of the center pillar outer 20 and the side member 30 to avoid interference between the electrode tips on the center pillar outer 20 side and the flange portions 12 of the center pillar inner 10.

The center pillar outer 20 is obtained by forming a plate material such that it has an approximately hat-shaped cross section, and mainly includes a recessed portion 21 that projects outward in the vehicle width direction and flange portions (i.e., first members) 22 that extend in the front-rear direction from opposite end portions of the recessed portion 21. Each flange portion 22 has, at (a part of) an end portion 22a thereof, protruding portions 23a (which are approximately circular in shape as seen in a side view in the drawing), each of which is formed by plastically deforming a part of the flange portion 22 such that the part of the flange portion 22 has a reduced thickness (i.e., thickness in the vehicle width direction) and the part of the flange portion 22 protrudes outward (in the front-rear direction) beyond the end portion 22a, provided at positions between adjacent run-off portions 13 of the center pillar inner 10, at predetermined intervals Ha in the vertical direction. The protruding portions 23a are provided in an extended manner in the front-rear direction so that the surfaces of the protruding portions 23a are flush with the surface on the inner side of the flange portion 22 (that is, the center pillar inner 10 on the flange portion 12 side), and are formed such that the protruding portions 23a are recessed from the surface on the outer side of the flange portion 22. In addition, the flange portion 22 also has, at (a part of) the end portion 22a thereof, protruding portions 23b (which are approximately circular in shape as seen in a side view in the drawing), each of which is formed by plastically deforming a part of the flange portion 22 such that the part of the flange portion 22 has a reduced thickness (i.e., thickness in the vehicle width direction) and the part of the flange portion 22 protrudes outward (in the front-rear direction) beyond the end portion 22a, provided at positions corresponding to the aforementioned run-off portions 13 of the center pillar inner 10, at predetermined intervals Hb in the vertical direction. The protruding portions 23b are provided in an extended manner in the front-rear direction so that the surfaces of the protruding portions 23b are flush with the surface on the outer side of the flange portion 22 (that is, the side member 30 on the flange portion 32 side), and are formed such that the protruding portions 23b are recessed from the surface on the inner side of the flange portion 22.

The side member 30 is obtained by forming a plate material such that it has an approximately hat-shaped cross section so as to cover the outer side of the center pillar outer 20, and mainly includes, like the center pillar outer 20, a recessed portion 31 that projects outward in the vehicle width direction and flange portions (i.e., second members) 32 that extend in the front-rear direction from opposite end portions of the recessed portion 31.

Herein, the center pillar outer 20 provided between the center pillar inner 10 and the side member 30 functions as a strength member that secures yield strength against external force that is applied in the vehicle width direction when a collision or the like occurs, and portions other than the protruding portions 23a and 23b of the center pillar outer 20 have a greater plate thickness than the center pillar inner 10 and the side member 30. Meanwhile, the protruding portions 23a are formed to approximately the same plate thickness as (the flange portions 12 of) the center pillar inner 10, and the protruding portions 23b are formed to approximately the same plate thickness as (the flange portions 32 of) the side member 30.

With respect to the aforementioned center pillar inner 10 and the center pillar outer 20, the surfaces on the outer side of the flange portions 12 of the center pillar inner 10 and the surfaces on the inner side of the flange portions 22 of the center pillar outer 20 (that is, the surfaces on the inner side of the protruding portions 23a) are made to contact each other so as to form a closed cross-sectional structure, and portions 12a between adjacent run-off portions 13 of the flange portions 12 and the protruding portions 23a are overlaid and are joined together through resistance welding (i.e., spot welding).

With respect to the center pillar outer 20 and the side member 30, the surfaces on the inner side of the flange portions 32 of the side member 30 and the surfaces on the outer side of the flange portions 22 of the center pillar outer 20 (that is, the surfaces on the outer side of the protruding portions 23b) are made to contact each other so that the side member 30 covers the outer side of the center pillar outer 20, and portions 32b of the flange portions 32 at positions corresponding to the run-off portions 13 and the protruding portions 23b are overlaid and are joined together through resistance welding (i.e., spot welding).

In the joined member with such a structure, the flange portions 22 of the center pillar outer 20, which is relatively thick, are joined at the end portions 22a thereof to the flange portions 12 of the center pillar inner 10 and the flange portions 32 of the side member 30 via the protruding portions 23a and 23b, which have been formed by plastically deforming parts of the flange portions 22 at the end portions 22a thereof such that the parts of the flange portions 22 have a reduced thickness and the parts of the flange portions 22 protrude outward beyond the end portions 22a. Accordingly, the thickness of the end portions 22a of the flange portions 22 of the center pillar outer 20 is partially reduced, and a load that acts on or around the end portions 22a of the flange portions 22 is reduced. Thus, the welding quality and the strength of the center pillar 1 as a joined member can be effectively increased. In addition, as the protruding portions 23a and 23b that are joined to the flange portions 12 of the center pillar inner 10 and the flange portions 32 of the side member 30, respectively, are formed by plastically deforming parts of the flange portions 22 such that the parts of the flange portions 22 protrude outward beyond the end portions 22a, it is possible to reduce the weight of the center pillar outer 20 or the center pillar 1 as a joined member thereof, and also reduce the material cost for producing the center pillar 1.

In particular, as the protruding portions 23a and 23b are formed to approximately the same thickness as each flange portion 12 of the center pillar inner 10 and each flange portion 32 of the side member 30, respectively, joining is performed such that the centers of nuggets that are formed through resistance welding are located at the contact plane between the flange portion 12 of the center pillar inner 10 and the flange portion 32 of the side member 30. Thus, it is possible to further increase the welding quality and the strength of the center pillar 1 as a joined member.

In the aforementioned embodiment, the run-off portions 13 made of cutouts are provided in the flange portions 12 of the center pillar inner 10 in order to join the center pillar outer 20 and the side member 30 together after joining the center pillar inner 10 and the center pillar outer 20 together. However, it is also possible to provide run-off portions made of cutouts in the flange portions 32 of the side member 30 at positions corresponding to the portions to be welded to the center pillar inner 10 and the center pillar outer 20 in order to avoid interference with welding marks and the like that occur when the center pillar inner 10 and the center pillar outer 20 are joined together.

In addition, in the aforementioned embodiment, the protruding portions 23a and 23b are formed to approximately the same thickness as each flange portion 12 of the center pillar inner 10 and each flange portion 32 of the side member 30, respectively, in order to increase the welding quality and the strength of the joined member. However, it is needless to mention that the welding quality and the strength of the center pillar 1 as a joined member can be increased as long as the thickness of at least the flange portions 22 of the center pillar outer 20, which is relatively thick, is reduced.

Further, it is needless to mention that the shapes of the protruding portions 23a and 23b, the positions of the protruding portions 23a and 23b at the end portions 22a, the ratio of the thickness of each of the protruding portions 23a and 23b to the thickness of the flange portions 22, and the like can be changed as appropriate in accordance with the joint strength, the specifications of electrode tips used for resistance welding, and the like.

### [Embodiment of Method for Producing Joined Member]

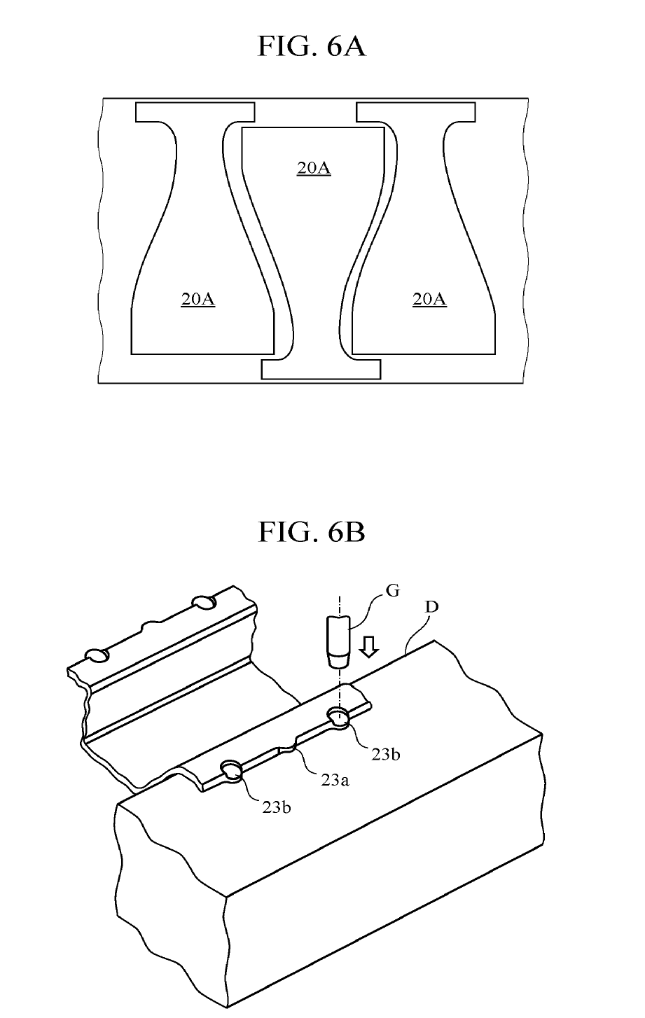

Next, a method for producing the aforementioned center pillar will be briefly described. First, as shown in FIG. 6A, center pillar outer materials 20A formed in three-dimensional shapes (i.e., which are approximately hat shapes in cross section and do not have the protruding portions 23a and 23b yet) are taken from a plate material such as a steel plate through press working. At this time, the center pillar outer materials 20A are taken from the plate material such that center pillar outer materials 20A that are alternately arranged in opposite directions are taken to reduce the pitch for taking the materials and increase the material yield.

Likewise, with respect to each of the center pillar inner 10 and the side member 30, materials formed in three-dimensional shapes (i.e., which are approximately hat shapes in the aforementioned cross section) are also taken from a plate material such as a steel plate through press working.

Next, as shown in FIG. 6B, each of the protruding portions 23a and 23b is formed by placing a flange portion of the center pillar outer material 20A on a base D, and pressing a presser G, which has a tip in a circular truncated cone shape, against a predetermined portion at the end portion (i.e., the front end portion or the rear end portion) of the flange portion of the center pillar outer material 20A in the thickness direction, and then partially press extending the end portion to plastically deform it so that the flange portion has a reduced thickness and a part of the flange portion protrudes outward beyond the end portion. At this time, the end portion is press extended by pressing the presser G against a predetermined portion at the end portion of the flange portion of the center pillar outer material 20A such that the center axis of the presser G is located at the end surface of the flange portion of the center pillar outer material 20A.

Herein, in order to form the protruding portion 23a, which is to be joined to the flange portion 12 of the center pillar inner 10, the presser G is pressed against the surface of the end portion of the flange portion of the center pillar outer material 20A on the outer side in the vehicle width direction at predetermined intervals Ha, so that the end portion of the flange portion is deformed inward from the outer side thereof due to the pressure, whereby the protruding portion 23a is formed such that the surface thereof is flush with the surface of the flange portion on the inner side in the vehicle width direction (i.e., the center pillar inner 10 on the flange portion 12 side). Meanwhile, in order to form the protruding portion 23b, which is to be joined to the flange portion 32 of the side member 30, the presser G is pressed against the surface of the end portion of the flange portion of the center pillar outer material 20A on the inner side in the vehicle width direction at predetermined intervals Hb, so that the end portion of the flange portion is deformed outward from the inner side due to the pressure, whereby the protruding portion 23b is formed such that the surface thereof is flush with the surface of the flange portion on the outer side in the vehicle width direction (i.e., the side member 30 on the flange portion 32 side). Accordingly, the center pillar outer 20 with the aforementioned protruding portions 23a and 23b is formed from the center pillar outer material 20A.

It is also possible to sequentially form the protruding portions 23a and 23b by sequentially pressing the presser G along the end portion of the flange portion of the center pillar outer material 20A. Alternatively, it is also possible to concurrently form a plurality of protruding portions 23a and 23b by using a plurality of pressers G and concurrently pressing the plurality of pressers G against a plurality of portions at the end portion of the flange portion of the center pillar outer material 20A (for example, by concurrently pressing the pressers G against all portions to be welded on the surface of the front end portion and/or the rear end portion of the flange portion of the center pillar outer material 20A on the inner side in the vehicle width direction, or concurrently pressing the pressers G against all portions to be welded on the surface on the outer side in the vehicle width direction).

The surface on the outer side of the flange portion 12 of the center pillar inner 10 is made to contact the surface on the inner side of the flange portion 22 of the center pillar outer 20 (that is, the surfaces on the inner side of the protruding portions 23a) such that they are approximately flush with each other, and the portion 12a between adjacent run-off portions 13 of the flange portion 12 and one protruding portion 23a are clamped with a pair of electrode tips, so that current is supplied across the pair of electrode tips to join the center pillar inner 10 and the center pillar outer 20 together (see FIG. 2).

Meanwhile, the surface on the outer side of the flange portion 22 of the center pillar outer 20 (i.e., the surfaces on the outer side of the protruding portions 23b), which has been joined to the center pillar inner 10, is made to contact the surface on the inner side of the flange portion 32 of the side member 30 such that they are approximately flush with each other, and the portion 32b of the flange portion 32 at a position corresponding to the run-off portion 13 and one protruding portion 23b are clamped with a pair of electrode tips, so that current is supplied across the pair of electrode tips to join the center pillar outer 20 (that is, a joined body obtained by joining the center pillar inner 10 and the center pillar outer 20 together) to the side member 30 (see FIG. 2). Accordingly, the center pillar 1 with the aforementioned structure, which has the center pillar inner 10, the center pillar outer 20, and the side member 30 joined together, is produced (see FIG. 3).

Although the embodiments of the present invention have been described in detail above, a specific structure is not limited thereto, and any design changes and the like that occur within the spirit and scope of the present invention are all included in the present invention.

### DESCRIPTION OF SYMBOLS

1 Center pillar
10 Center pillar inner
11 Recessed portion of center pillar inner
12 Flange portion of center pillar inner (i.e., second member)
13 Run-off portion
20 Center pillar outer
21 Recessed portion of center pillar outer
22 Flange portion of center pillar outer (i.e., first member)
22a End portion of flange portion
23a, 23b Protruding portion
30 Side member
31 Recessed portion of side member
32 Flange portion of side member (i.e., second member)
D Base
G Presser

1. A joined member comprising a first member and a second member joined together through resistance welding, the first member being relatively thick and the second member being relatively thin,
wherein the first member and the second member are joined together via a protruding portion, the protruding portion having been formed by plastically deforming a part of the first member at an end portion thereof such that the part of the first member has a reduced thickness and the part of the first member protrudes outward beyond the end portion.

2. The joined member according to claim 1, wherein the protruding portion is provided in an extended manner so that a surface of the protruding portion is flush with a surface of the first member on the second member side.

3. The joined member according to claim 1, wherein the protruding portion has the same thickness as a welded portion of the second member.

4. The joined member according to claim 1, wherein the first member forms a flange portion of a member, the member having a hat-shaped cross section and having a recessed portion and the flange portion that is continuous with opposite end portions of the recessed portion.

5. A method for producing a joined member, the joined member having a first member and a second member joined together through resistance welding, the first member being relatively thick and the second member being relatively thin, the method comprising:
forming a protruding portion by plastically deforming a part of the first member at an end portion thereof such that the part of the first member has a reduced thickness and the part of the first member protrudes outward beyond the end portion; and
joining the first member and the second member together through resistance welding via the protruding portion.

6. The method for producing a joined member according to claim 5, wherein the protruding portion includes a plurality of protruding portions, and the method further comprises sequentially forming the plurality of protruding portions or concurrently forming the plurality of protruding portions.

7. The method for producing a joined member according to claim 5, further comprising:
forming the protruding portion such that a surface of the protruding portion is flush with a surface of the first member on the second member side; and
making a surface of the protruding portion on the second member side to contact a surface of the second member on the first member side, thereby joining the first member and the second member together.

8. The joined member according to claim 2, wherein the protruding portion has the same thickness as a welded portion of the second member.

9. The method for producing a joined member according to claim 6, further comprising:
forming the protruding portion such that a surface of the protruding portion is flush with a surface of the first member on the second member side; and
making a surface of the protruding portion on the second member side to contact a surface of the second member on the first member side, thereby joining the first member and the second member together.
